(19) United States
(12) Patent Application Publication
(10) Pub. No.: US 2007/0283095 A1
(43) Pub. Date: Dec. 6, 2007

(54) Method to access storage device through universal serial bus

(75) Inventors: Chi-Tung Chang, Taipei City (TW); Shih-Hsien Yang, Junghe City (TW); Ching-Wen Wang, Sijhih City (TW)

Correspondence Address: HOFFMANN & BARON, LLP, 6900 JERICHO TURNPIKE, SYOSSET, NY, 11791, US

(73) Assignee: ALCOR MICRO, CORP.

(21) Appl. No.: 11/447,571

(22) Filed: Jun. 6, 2006

(51) Int. Cl. G06F 12/00

(52) U.S. Cl. 711/115; 711/103

(57) ABSTRACT

A method to access storage device through universal serial bus (USB) is disclosed in the present invention. The storage device includes a flash controller and a flash memory. The method includes: (1)connecting the storage device to a USB interface of an electronic device such as a computer; (2)transferring a plurality of access (reading/writing) instructions to a flash controller from the electronic device;(3)deciding which data needed to be temporarily saved in a flash random access memory and the priority order of the access instructions according to a mapping table of a flash file system by the flash controller; (4)writing the data temporarily saved in the flash random access memory into the flash memory according to the priority order by the flash controller. The method can enhance the operation efficiency of the storage device.

### BACKGROUND OF THE INVENTION

1. Field of the Invention

The present invention relates to a method to access a storage device, and more particularly to a method to access a storage device through universal serial device(USB).

2. Description of the Related Art

Because of the high development in electronic technology, the demand of the consumers in the portable storage device is increasing. The capacity of the portable storage device has become larger and larger and the size of the portable storage device smaller and smaller. It is to be noted that the market of portable storage device using universal serial bus (USB) interface has been growing rapidly.

In the conventional method for accessing a storage device with flash memory data has to be moved repeatedly into and from a buffer which is usually provided in the storage device and can be accessed by the controller of the storage device. The need of repeating moving data is time-consuming when all read/write instructions have to be executed without being filtered according to a priority strategy. Therefore, the operation efficiency of the storage device is seriously limited.

Therefore, it is the objective of the present invention to provide a method that can decrease the frequency of moving data into and from the buffer and optimize the operation order by rearranging the instructions according to a priority criterion, so that the efficiency of accessing the storage device can be enhanced.

### SUMMARY OF THE INVENTION

A method to access storage device through universal serial bus (USB) is disclosed in the present invention. The main objective of the present invention is to improve the accessing efficiency of the storage device with flash memory by preventing from repeatedly moving data into and from the buffer without deciding a priority of the read/write instructions. The buffer is provided in the storage device and can be accessed by the flash controller of the storage device. The present invention provides a method to access storage device through USB and the storage device including a flash controller and a flash memory. The method comprises:

(1) connecting the storage device to a USB interface of an electronic device;

(2) outputting a plurality of accessing instructions to the flash controller by the electronic device

(3) deciding which data needed to be temporarily saved in a flash random access memory and a priority order of the access instruction according to a mapping table of a flash file system by the flash controller;

(4) executing the access instructions according to the priority order by the flash controller and writing the data temporarily saved in the flash random access memory into the flash memory.

### BRIEF DESCRIPTION OF THE DRAWINGS

Characteristics and advantage of the present invention will be more clearly understood by referring to accompanied drawings wherein:

FIG. 1 is a system view illustrating a method to access storage device through universal serial bus according to the present invention.

FIG. 2 is a view illustrating the logic memory structure and the mapping table based on which a method to access storage device through universal serial bus according to the present invention can be realized.

FIG. 3 is a flow chart illustrating an embodiment of a method to access storage device through universal serial bus according to the present invention.

FIG. 4 is a flow chart illustrating another embodiment of a method to access storage device through universal serial bus according to the present invention.

### DESCRIPTION OF THE PREFERRED EMBODIMENTS

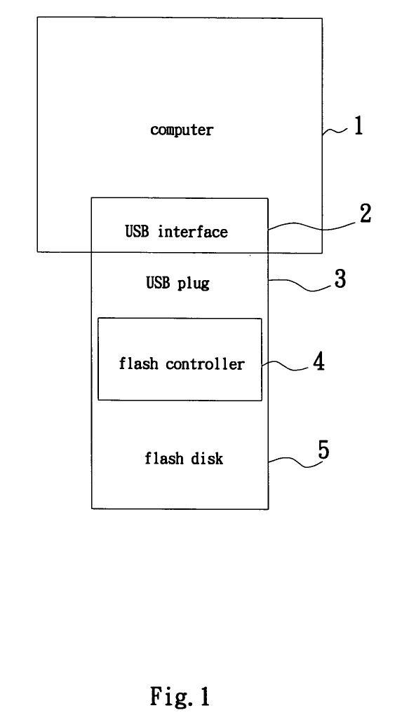

FIG. 1 is a system view illustrating a method to access storage device through universal serial bus according to the present invention. As shown in FIG. 1, in a method to access storage device through universal serial bus (USB) a flash disk 5 is utilized as the storage device in the present invention. The USB flash disk 5 includes a flash controller 4 and a USB plug 3. When using the method of the present invention to access storage device through USB, the USB plug 3 is connected to a USB interface 2 of a computer 1. The computer 1 outputs an access (read/write) instruction to the flash controller 4, and the flash controller 4 decides which data contained in the access instruction is needed to be temporarily saved into the flash random access memory and determines a priority order of the access instruction according to a mapping table of a flash file system. Finally, the flash controller 4 executes the access instruction according to its priority order, writingthe data temporarily saved in the flash random access memory into the flash memory.

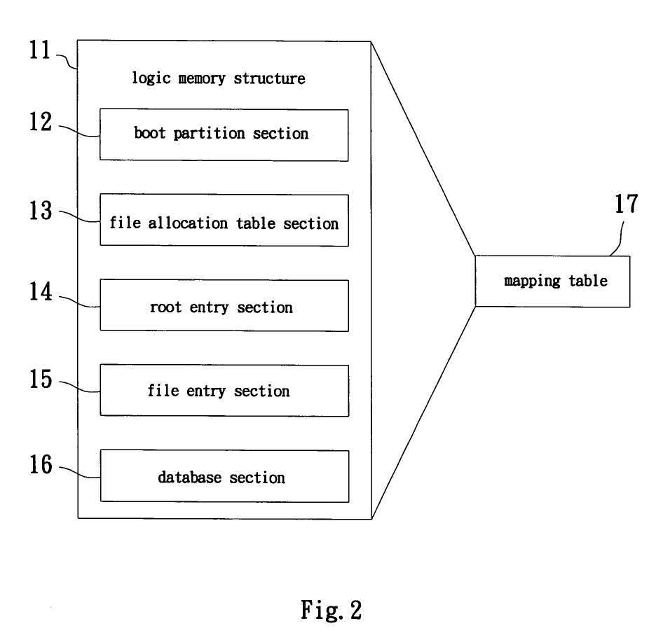

FIG. 2 is a view illustrating a logic memory structure 11 and a mapping table 17 based on which a method to access storage device through USB of the present invention can be realized. As shown in FIG. 2, the mapping table 17 is a reference for the logic memory structure 11 in the flash file system. The flash file system in accordance with a logic memory structure 11 includes a boot partition section 12, a file allocation table section 13, a root entry section 14, a file entry section 15, a database section 16. The flash controller 4 will decide which data is needed to be saves in a flash random access memory and determine the priority sequence of the access instruction according to the mapping table 17 in the flash file system.

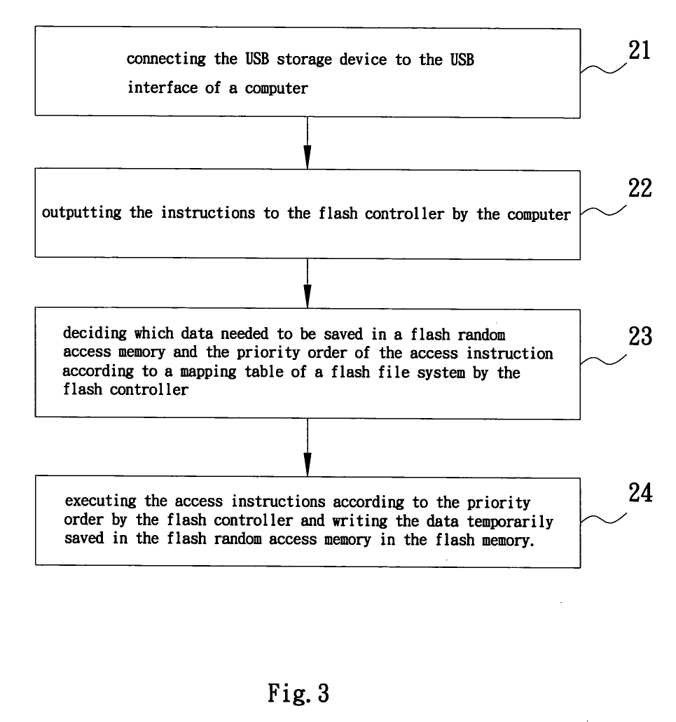

FIG. 3 is a flow chart illustrating an embodiment of a method to access storage device through USB according to the present invention. The method includes the following steps:
Step 21: connecting the USB device to the USB interface of a computer;
Step 22: outputting the instructions to the flash controller by the computer;
Step 23: deciding which data is needed to be saved in a flash random access memory and determining the priority order of the access instruction according to a mapping table of a flash file system by the flash controller, wherein the mapping table is a reference for the flash file system in accordance with a logic memory structure, and the flash file system in accordance with a logic memory structure including a boot partition section, a file allocation table section, a root entry section, a file entry section and a database section;
Step 24: executing the access instructions according to the priority order by the flash controller and writing the data temporarily saved in the flash random access memory into the flash memory.

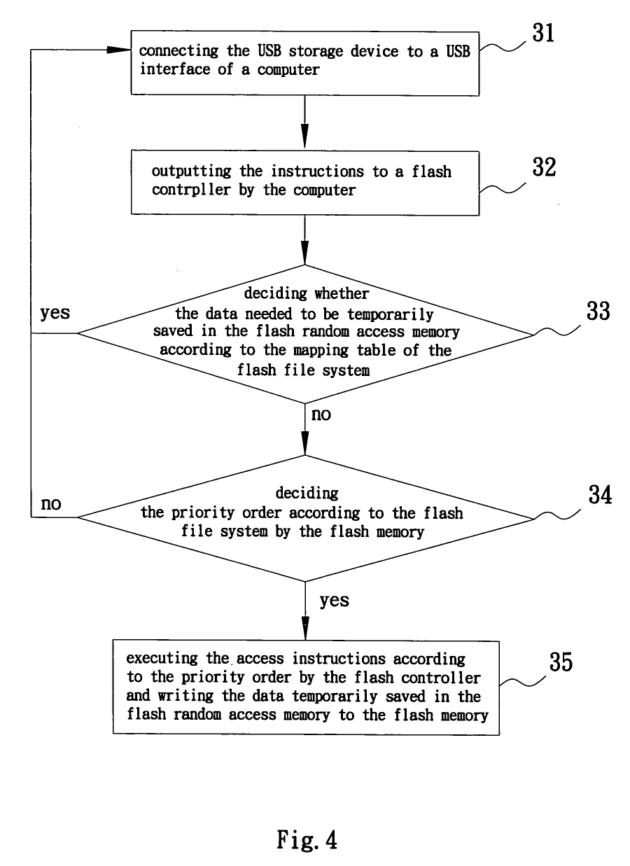

FIG. 4 is a flow chart illustrating another embodiment of a method to access storage device through universal serial bus according to the present invention. The method includes the following steps:
Step 31: connecting the USB device to an USB interface of a computer;
Step 32: outputting the instructions to a flash controller by the computer;
Step 33: deciding whether the data is needed to be temporarily saved in the flash random access memory according to the mapping table of the flash file system so that if some of the data is needed to be temporarily saved in the file entry section or the file entry section, returning to Step 32, otherwise, proceeding to the next step;
Step 34: deciding the priority order according to the flash file system by the flash memory, if the instruction has a priority, proceeding to the next step, otherwise, returning to Step 32;
Step 35: executing the access instructions according to the priority order by the flash controller and writing the data temporarily saved in the flash random access memory into the flash memory.

According to the description above, it is clear that the method can be used to access storage devices via the USB. Because the data is not needed to be repeatedly moved into and from buffer and the priority order of the access instructions can be determined while controlling the data and the instruction access, the efficiency of accessing data can be improved by the method of the present invention. In the method of the present invention the frequency of moving data into and from the buffer can be decreased and the priority of the access instructions can be appropriately determined to optimize the efficiency of accessing the storage device.

While the present invention has been illustrated by the preferred embodiments thereof, it will be understood by those skilled in the art that various changes in form and details may be effected therein without departing from the spirit and scope of the present invention as defined by the appended claims.

1. A method to access a storage device through universal serial bus (USB), wherein the storage device comprises a flash controller and a flash memory, and the method comprising:
(1) connecting the storage device to a USB interface of an electronic device;
(2) outputting a plurality of access instructions to the flash controller by the electronic device;
(3) deciding which data needed to be temporarily saved in a flash random access memory and a priority order of the access instructions according to a mapping table of a flash file system by the flash controller; and
(4) executing the access instructions according to the priority order by the flash controller and writing the data temporarily saved in the flash random access memory into the flash memory.

2. The method according to claim 1, wherein the step 3 further comprises:
(31) deciding whether the data are needed to be saved in the flash random access memory according to the mapping table of the flash file system by the flash controller, if yes, saving the data into the flash random access memory and returning to step (1), otherwise, proceeding to step (32);
(32) deciding the priority order of the access instructions according to the flash file system by the flash controller, if the access instructions do not have priority, recurring to step (1), otherwise, proceeding to step (4).

3. The method according to claim 2, wherein the flash file system further comprises a boot partition section, a file allocation table section, a root entry section, a file entry section and a database section.

4. The method according to claim 3, wherein the step (31) further comprises: making the positive decision (yes) if the plurality of data is to be saved in the file allocation table section or the file entry section, otherwise, making the negative decision.
